(19) United States
(12) Patent Application Publication
(10) Pub. No.: US 2015/0047553 A1
(43) Pub. Date: Feb. 19, 2015

(54) REAR-MOUNTED INSTRUMENTED MODULE FOR A DASHBOARD

(71) Applicant: SONCEBOZ AUTOMOTIVE SA, Sonceboz (FR)

(72) Inventors: Sébastien Heinrich, Steinbourg (FR); Martin Strahm, Boudry (CH)

(73) Assignee: SONCEBOZ AUTOMOTIVE SA, Sonceboz (FR)

(21) Appl. No.: 14/379,953

(22) PCT Filed: Feb. 19, 2013
(86) PCT No.: PCT/FR2013/050341

§ 371 Date: Aug. 20, 2014

(30) Foreign Application Priority Data
Feb. 23, 2012 (FR) 1251634

(51) Int. Cl. G01D 13/26

(52) U.S. Cl. CPC G01D 13/265
USPC 116/288

(57) ABSTRACT

An indicator module for a dashboard, including an electric motor, a mechanical motion-reduction unit, an output shaft, a housing, and a light source. The electric motor is mechanically and electrically connected to a first surface of a printed circuit and drives a visual indicator about an axis of rotation via the reduction unit and the output shaft through the printed circuit such that the indicator provides visual information beyond a second surface of said printed circuit. The light source is positioned on the first or second surface of the printed circuit sending a light flow toward the axis of rotation. The housing has a light case, which extends beyond the second surface of the printed circuit and which is formed around the axis of rotation of the visual indicator.

### CROSS-REFERENCE TO RELATED APPLICATIONS

This application is a National Phase Entry of International Application Serial No. PCT/FR2013/124580, filed on Feb. 19, 2013, which claims priority to French Patent Application Serial No. 1251634, filed on Feb. 23, 2012, both of which are incorporated by reference herein.

### FIELD OF THE INVENTION

The present invention relates to the field of electric stepper motors for precisely positioning an element according to an angular position generally less than 360°. It relates more specifically to a so-called “rear” indicator module for a dashboard, signifying that it is installed behind the printed circuit whereas the element to be positioned provides the information in front of the printed circuit.

### BACKGROUND

The field of electric stepper motors for a dashboard is already familiar from Japanese patent JP2010 197275. This document describes a module comprising an electric motor with a mechanical reduction unit controlling an output shaft illuminated by a light-emitting diode. Such devices of the prior art are also known from patents JP2009 192290, U.S. Patent Publication No. 2006/243191, JP2010 276592 or EP1519159.

These documents of the prior art, offering solutions for illuminating a rear-mounted indicator module, all display a major flaw involving the significant increase in the inertia of the illuminated indicator or the output shaft bearing the illuminated indicator. This increase in inertia is detrimental to proper use of the module not only owing to an increase in the needle reaction time but also owing to an increase in the overhang in the area of the guidance of the output shaft or the illuminated indicator. These disadvantages entail greater mechanical constraints in the area of the bearings supporting the output shaft.

Furthermore, the optical yield of the solutions of the prior art is not optimum and results in light losses at the interface between the LED and the indicator.

### SUMMARY

The aim of the invention is to illustrate a rear-mounted indicator module for a dashboard allowing additional visual information elements of the indicator light type to be housed near the head of the indicator while retaining good luminosity of the indicator needle and an indicator inertia reduced to a minimum in relation to the solutions of the prior art.

Another aim of the invention is to provide a simple solution in terms of electrical connection.

More specifically, the invention relates to an indicator module for a dashboard consisting of an electric motor, a mechanical motion-reduction unit, an output shaft, a housing and a light source, said electric motor being mechanically and electrically connected to a first surface of a printed circuit and driving a visual indicator around an axis of rotation via said reduction unit and the output shaft through the printed circuit such that said indicator provides visual information beyond a second surface of said printed circuit, characterised in that said light source is positioned on the first or second surface of the printed circuit so as to send a light flow according to a direction of emission perpendicular to the axis of rotation and whereby said indicator is capable of transmitting at least a portion of said light flow in the direction of the axis of rotation. The housing features a light case, which extends beyond the second surface of the printed circuit and which is formed around the axis of rotation of the visual indicator. The function of this light case is to limit the loss of light flow outside the indicator.

In a preferred embodiment, the housing contains the electric motor and the mechanical reduction unit and the light source is positioned on the second surface of the motor and the housing features a light case, which extends beyond the second surface of the printed circuit and which is formed around the axis of rotation of the visual indicator.

The output shaft is preferably a hollow shaft having a female-type mechanical connection; the indicator features a male-type mechanical connection matching said female-type connection of said output shaft. The indicator preferably has a surface diffracting the light opposite said light source in order to reflect the light towards the indicator needle. Advantageously, the output shaft has a reflective surface opposite said light source. The light case advantageously has an opening opposite the light source.

In an alternative embodiment, a light guide is placed around the light case and the light source in order to collect the small amount of light escaping from the light case and avoid a halo. Preferably, the light case locally features a form of bearing guiding the visual indicator. The light source is preferably a light-emitting diode, but may be another means available to the person skilled in the art. In a preferential embodiment, one end of the visual indicator takes the form of pointer moving parallel to the printed circuit above a display screen and whereby said indicator has a prism that reflects the light flow perpendicularly from the axis of rotation of the indicator towards said needle.

### DETAILED DESCRIPTION OF THE FIGURES

The characteristics and advantages of the invention will become apparent below on reading detailed embodiments with reference to the appended figures which represent respectively:

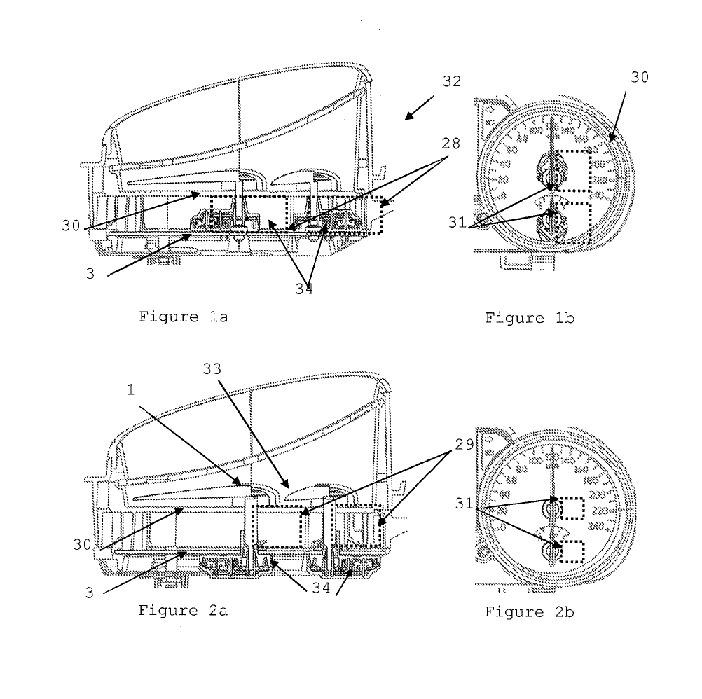

FIGS. 1a and 1b: a dashboard, respectively in a cross-sectional and front view according to an embodiment of the prior art;

FIGS. 2a and 2b: a dashboard, respectively in a cross-sectional and front view using two indicator modules according to a preferred embodiment of the invention;

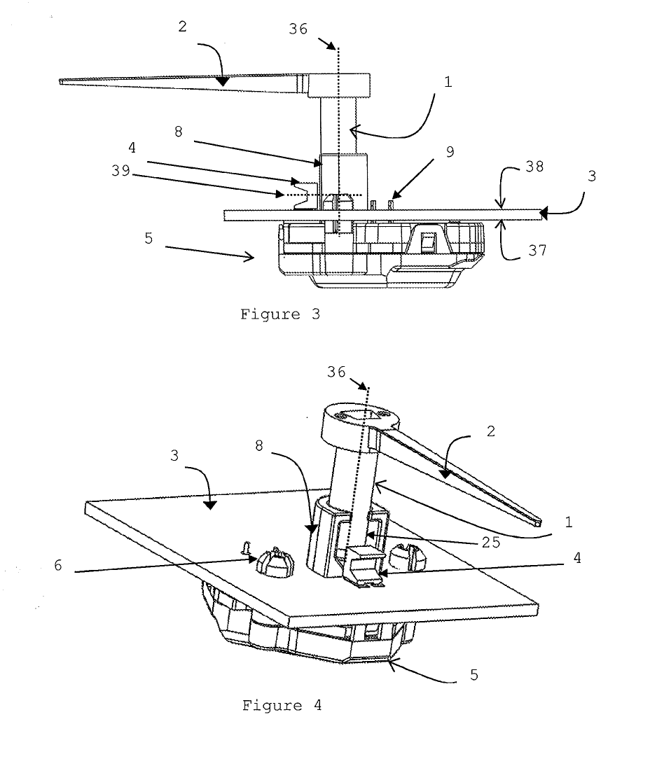

FIG. 3: the indicator module in a first embodiment in a side view;

FIG. 4: the indicator module in a first embodiment in a three-quarter view;

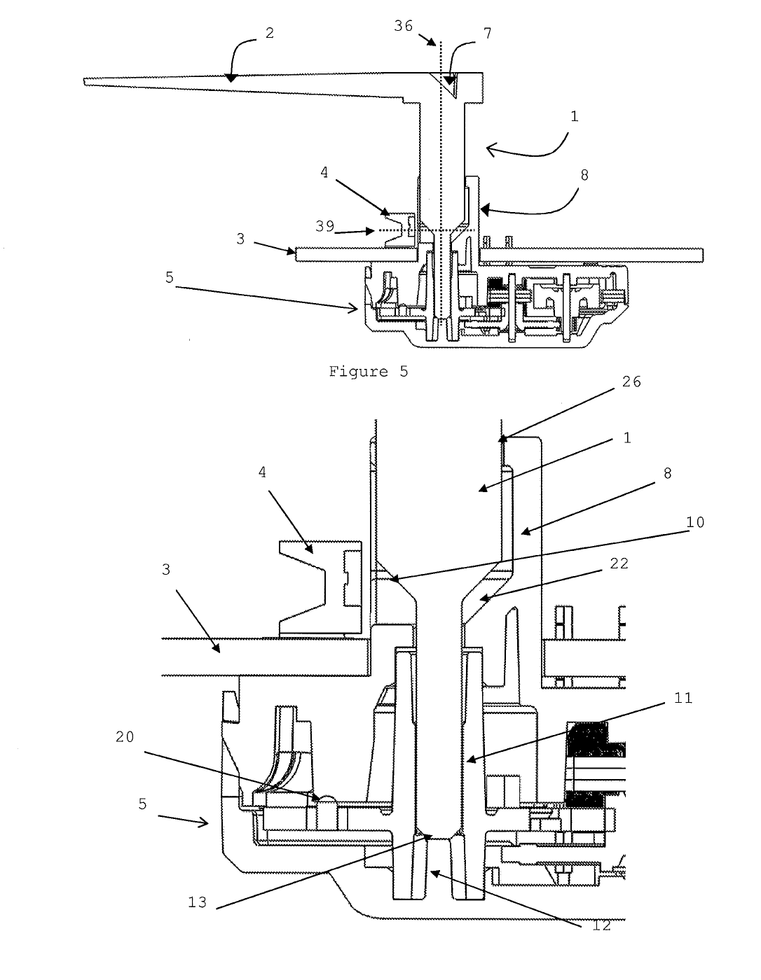

FIG. 5: the indicator module in a first embodiment in a cross-sectional view;

FIG. 6: a detailed view of FIG. 5;

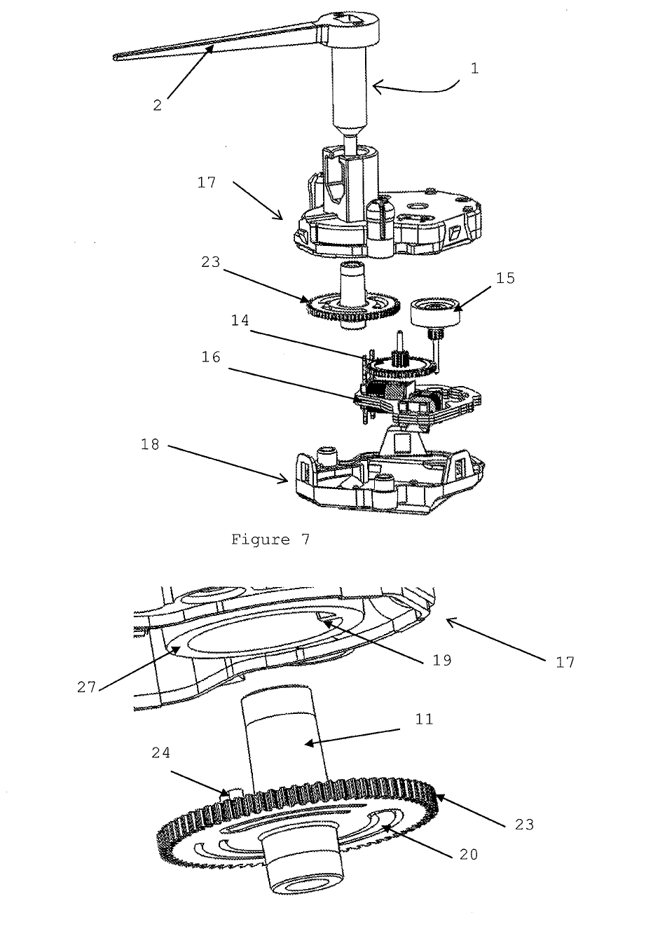

FIG. 7: an exploded view of the first embodiment;

FIG. 8: a detailed view of the output wheel of the indicator;

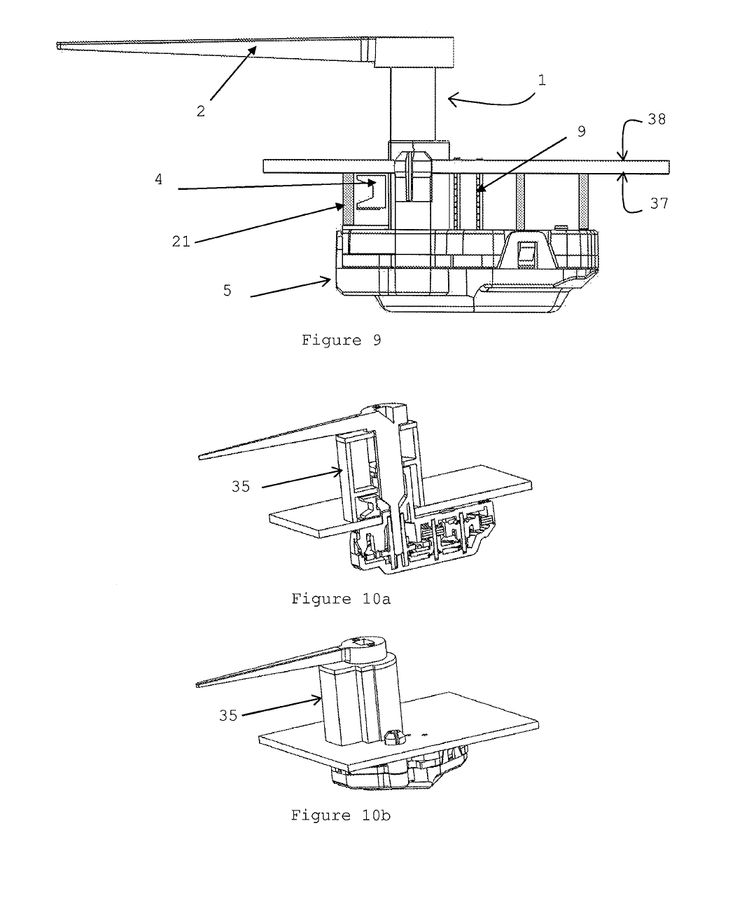

FIG. 9: the indicator module in a second embodiment in a side view; and

FIGS. 10a and 10b: a third embodiment.

### DETAILED DESCRIPTION

In the description of the figures, we consider that the light source is in the form of a light-emitting diode (LED) (4) of CMS type, as for example produced by the OSRAM company under reference A67F. The invention is not however restricted to sole use of an LED of this kind and any equivalent light source may be considered without affecting the spirit of the invention.

FIGS. 1a and 1b represent an embodiment of a dashboard (32) according to the prior art using two indicator modules (34), the installation of which is in front of the printed circuit (3). Since the modules (34) occupy the entire space between the printed circuit (3) of the display screen (30), installation of other additional sources of visual information is impossible. Hence, the volumes (28) determined by the maximum dimensions of the module (34) determine on the surface of the display screen (30) a large area (31) that will not be able to feature any additional display.

An indicator module using a rear-mounted motor allows far better integration in the dashboard (32) as shown by FIGS. 2a and 2b. Given that the module (34) is installed behind the printed circuit (3), it leaves a larger volume free, such that only the volumes (29) determined by the width of the head (33) of the indicator (1) prevent installation of other additional sources of visual information. On the surface of the display screen (30), the area (31) which cannot have any additional display is small and does not extend beyond the width of the head (33) of the indicator (1).

FIG. 3 illustrates an indicator module for a dashboard according to the invention and a preferred embodiment. It comprises a visual indicator (1), one of the ends of which takes the form of a needle (2) visible to the driver and which one wishes to illuminate and which extends beyond the second surface (38) of the printed circuit (3), which is the upper surface in this FIG. 3. This indicator (1) is mechanically connected to an output shaft (not visible) controlled by an electric motor enclosed in a housing (5). This housing (5) is positioned on the first surface (37) of the printed circuit (3), which is the lower surface in this case and the electric motor contained in the housing (5) drives, according to the axis of rotation (36), the indicator (1) via the printed circuit (3). On the second surface (38) of the printed circuit (3), a light source is placed, in this case in the form of an LED (4), which transmits the light flow according to a direction of emission (39) parallel to the printed circuit (3) in the indicator (1). The housing (5) is extended through the printed circuit (3) beyond the second surface (38) by a light case (8) which has an opening allowing the light flow emitted by the LED (4) to reach the indicator (1).

This light case (8) forms an opaque sleeve surrounding the base of the axis of the indicator (1). This light case (8) has a reflective surface and features a side window communicating with the light-emitting diode (4). This sleeve extends the housing in order to allow moulding in a single piece. The function of the light case (8) is thus to restrict the loss of light flow outside the indicator (1). The light flow of the LED (4) is reflected according to the axis of rotation (36) towards the top of the indicator in the direction of the needle (2) of the indicator (1). The motor contained in the housing (5) is connected electrically by connecting tabs (9) that come into contact with the printed circuit (3) to which they are joined by a soldered or unsoldered connection.

FIG. 4 illustrates this same module according to a three-quarter view in which one can also see the mechanical connection of the housing established by means of deformable connection elements (6) that interact with drillings in the printed circuit (3). The opening (25) of the light case (8) is also visible opposite the LED (4) which therefore transmits its light flow into the indicator (1) through this opening (25).

FIG. 5 still shows the preferred embodiment of the module, but in a cross-sectional view in which the elements previously described are to be found and also the inside of the housing (5). These elements are described in particular opposite FIG. 6 which shows a cross-sectional detailed view of the inside of the housing (5).

The motor has a hollow output shaft (11) providing an additional female-type binding with the male-type binding of the indicator (1). This output shaft (11) is interdependent with an output wheel (23) having friction arms (20) allowing generation of a constant friction conducive to fluid movement of the indicator (1). The end of the indicator is formed by a low end (13) in contact with an axial stop (12) which is interdependent with the housing (5).

Beyond the printed circuit (3) on the side of the second surface (38) of the printed circuit (3), the LED (4) transmits its light flow through the opening (25) in the light case (8) into the indicator (1). This indicator (1) has a deflector (10) which is an oblique shape forming an angle close to 45° in relation to the surface of the printed circuit (3). With the LED (4) transmitting its light flow in a predominately parallel direction to the printed circuit (3), in the direction of emission (39), a major portion of the light flow is thus diffracted by the deflector (10) in order to reach the upper part of the indicator (1) in the direction of the needle (2) according to the axis of rotation (36).

In order to optimise further the light flow collected by the indicator (1), since the LED emits at a solid angle on the order of 120° for conventional products, it may be useful to employ the light case (8) in order to avoid loss of light around the indicator (1) and reflect a major portion of this light not directly collected into the indicator (1). To this end, the light case (8) advantageously features a deflector (22) in the form of an oblique inside surface forming a 45° angle with the surface of the printed circuit (3) in order to reflect the light towards the upper part of the indicator (1). This deflector (22) of the light case (8) is to be ideally in mirror-polished finish in order to maximise its reflective power.

In order to optimise guidance of the indicator (1), the latter is guided beyond the first surface of the printed circuit (3) by the output shaft (11), which is itself guided in the housing (5) and furthermore beyond the second surface (38) of the printed circuit (3) by the light case (8), the upper end of which forms a bearing (26) in sliding contact with the indicator (1). This bearing (26) is ideally integral with the light case (8) by being the extension thereof.

In order to limit the size of the output shaft (11) and of the output wheel (23), the indicator (1) has a diameter minimised on its lower part in the area of contact with the output shaft (11), whereas it presents a diameter increased in the area of collection of the light flow and of the bearing (26) of the light case (8). This increased diameter will not be maximised however in order to avoid excessively increasing the inertia of the indicator (1).

Typically, the smaller diameter of the indicator (1) in the area of the output shaft (11) is on the order of 2 mm and the larger diameter in the area of the bearing (26) is on the order of 6 mm without these values constituting a functional restriction.

FIG. 7 illustrates an exploded view of the preferred embodiment in which one can see, in addition to the elements already described above, the electric motor consisting of a wound stator (16), a magnet (15) in the form of a multipolar ring driven in rotation by the action of the magnetic flux generated by the wound stator (16), of a mechanical reduction unit formed of an intermediate wheel (14) and an output wheel (23). The housing (5) consists of a first cover (17) extended here by the light case (8) and by a second cover (18) fixed on the first cover (17).

FIG. 8 illustrates a detailed view of the output wheel (23), in this case integral with the output shaft (11) and having on the one hand arms (20) that rub against a track (27) on the first cover (17) and on the other hand a stop (24) contacting the angular stop (19) interdependent with the first cover (17).

FIG. 9 illustrates an alternative embodiment of a module in which the LED (4) is positioned on the same side of the printed circuit (3) as the housing (5) on the first surface (37) of the printed circuit (3). In order to retain a housing similar to that shown for the preferred embodiment, it may therefore be considered placing the housing (5) to the printed circuit (3) by means of columns (21). The wound stator (16) is connected to the printed circuit by the extension of the electrical connecting tabs (9). It is also possible to consider placing the LED (4) inside the housing (5), which requires modification of at least one of the first or second covers (17, 18).

FIGS. 10a and 10b show an alternative embodiment in which a light guide is added (35) surrounding the light case (8) and which allows collection of the small amount of light escaping from the light case (8) in order to avoid any possible halo problem behind the visual indicator (1).

1. An indicator module for a dashboard comprising an electric motor, a mechanical motion-reduction unit, an output shaft, a housing and a light source, said electric motor being mechanically and electrically connected to a first surface of a printed circuit and driving a visual indicator around an axis of rotation via said reduction unit and the output shaft through the printed circuit such that said indicator provides visual information beyond a second surface of said printed circuit, said light source being positioned on the first surface or second surface of the printed circuit so as to send a light flow in the direction of the axis of rotation, wherein said housing has a light case which extends beyond the second surface of the printed circuit and which is formed around the axis of rotation of the visual indicator.

2. The indicator module for a dashboard according to claim 1, wherein said output shaft is a hollow shaft having a female-type mechanical connection and in that said indicator features a male-type mechanical connection matching said female-type connection of said output shaft.

3. The indicator module for a dashboard according to claim 1, wherein said indicator has a surface diffracting the light opposite said light source.

4. The indicator module for a dashboard according to claim 1, wherein the output shaft has a reflective surface opposite said light source.

5. The indicator module for a dashboard according to claim 4, wherein said light case has an opening opposite the light source.

6. The indicator module for a dashboard according to claim 5, wherein a light guide is placed around the light case and the light source.

7. The indicator module for a dashboard according to claim 1, wherein the light case locally features a form of bearing guiding the visual indicator.

8. The indicator module for a dashboard according to claim 1, wherein the light source is a light-emitting diode.

9. The indicator module for a dashboard according to claim 1, wherein one end of the visual indicator takes the form of pointer moving parallel to the printed circuit above a display screen and in that said indicator has a prism that reflects the light flow perpendicularly from the axis of rotation of the indicator towards said needle.

10. The indicator module for a dashboard according to claim 1, wherein said output shaft is a hollow shaft having a female-type mechanical connection and in that said indicator features a male-type mechanical connection matching said female-type connection of said output shaft;
wherein said indicator has a surface diffracting the light opposite said light source.

11. The indicator module for a dashboard according to claim 10, wherein the output shaft has a reflective surface opposite said light source.

12. The indicator module for a dashboard according to claim 11, wherein said light case has an opening opposite the light source.

13. The indicator module for a dashboard according to claim 12, wherein a light guide is placed around the light case and the light source.

14. The indicator module for a dashboard according to claim 10, wherein the light case locally features a form of bearing guiding the visual indicator.

15. The indicator module for a dashboard according to claim 10, wherein the light source is a light-emitting diode.

16. The indicator module for a dashboard according to claim 10, wherein one end of the visual indicator takes the form of pointer moving parallel to the printed circuit above a display screen and in that said indicator has a prism that reflects the light flow perpendicularly from the axis of rotation of the indicator towards said needle.

17. The indicator module for a dashboard according to claim 10, wherein said light case has an opening opposite the light source.

18. The indicator module for a dashboard according to claim 17, wherein a light guide is placed around the light case and the light source.
